(19) United States
(12) Patent Application Publication
(10) Pub. No.: US 2003/0112345 A1
(43) Pub. Date: Jun. 19, 2003

(54) Camera capable of compressing image data

(76) Inventors: Takehisa Yamaguchi, Ikoma-Shi (JP); Yoshio Nakagawa, Osaka (JP); Satoshi Yokota, Osaka (JP)

Correspondence Address: MCDERMOTT WILL & EMERY, 600 13TH STREET, N.W., WASHINGTON, DC, 20005-3096, US

(21) Appl. No.: 10/264,268

(22) Filed: Oct. 4, 2002

(30) Foreign Application Priority Data
Oct. 5, 2001 (JP) 2001-310114

(51) Int. Cl. H04N 5/76; H04N 5/225

(52) U.S. Cl. 348/231.6; 348/231.9; 348/373; 348/333.02; 348/211.1; 386/109

(57) ABSTRACT

Image data obtained through image capturing are held on an internal memory 23. The image data are compressed by a CPU 22, recorded on a memory card 45, and sent by a communications interface 46, a Bluetooth™ transmission module 50, a portable telephone function unit 52 or the like. The CPU 22 is capable of compressing the image data at different compression ratios which are different between recording and sending. In this case, the image data held on the internal memory 23 are compressed at the different compression ratios and recorded in mutually different recording regions of the memory card.

This application is based on application No. 2001-310114 filed in Japan, the content of which is hereby incorporated by reference.

### BACKGROUND OF THE INVENTION

1. Field of the Invention

The present invention relates to a digital camera equipped with a communications function, and more particularly, to a digital camera equipped with a communications function which is capable of compressing image data and recording and sending compressed image data.

2. Description of the Related Art

A variety of proposals have been made as to a digital camera equipped with a communications function which compresses captured image data to thereby reduce the size of the data, and records or sends such image data.

For example, for a situation that a recorded image which is not compressed is to be sent via a modem using a digital camera which is capable of executing compressed recording and non-compressed recording, there are known techniques of compressing data and sending the data.

Also known are techniques of preparing a plurality of modes, such as a mode for compressing a captured image and transmitting the captured image, a mode for transmitting a captured image as it is not compressed and a mode for transmitting an image which is on a recording medium, and selectively using the plurality of modes.

To automatically select an image processing condition (such as a compression ratio) in accordance with whether recorder is selected or communications means is selected is also known. Other conventional techniques require to prepare two or more types of parameters for signal processing and create two or more types of different image data from one captured image.

Since there is a restriction upon a data transmission speed of a conventional digital camera, a customary approach is to increase a compression ratio of transmission data, accordingly reduce the size of the image data and send to a server. However, a server has a far larger recording capacity than the recording capacity of a camera. A demand therefore is to send high quality image data as they are before compressed to a server and keep the data in the server while recording image data at an appropriate compression ratio on a recording medium of a camera.

Further, in the case of compression by an irreversible compression scheme, if the compression ratio of image data recorded on a recording medium of a digital camera is set higher than the compression ratio of image data which are to be sent, image data at a low compression ratio need be created from image data at a high compression ratio, which deteriorates an image quality and is not hence desirable.

Meanwhile, a large-capacity recording medium, such as a micro drive, which can be inserted into a slot of a camera has been put into a practical use, and it has now become possible to record non-compressed image data whose data size is large. In some cases, it is desirable that data to be recorded are pre-compressed image data and data to be sent are compressed data.

### SUMMARY OF THE INVENTION

An object of the present invention is to provide a camera equipped with a communications function which is capable of effectively utilizing image data at various compression ratios.

One aspect of the present invention provides a camera which is capable of recording and sending image data, comprising: a temporary memory which holds image data obtained through image capturing; a data compressor which accepts setup regarding a compression ratio for sending and setup regarding a compression ratio for recording and accordingly compresses the image data recorded on the temporary memory at the respective compression ratios; and a memory controller which ensures that the image data compressed at the compression ratio for sending and the image data compressed at the compression ratio for recording are recorded independently in different regions of a memory.

In the structure above, the image data obtained through image capturing, namely, pre-compressed image data are held on the temporary memory. It is therefore possible to independently set the compression ratio for recording the image data and the compression ratio for sending the image data.

In the structure above, when the compression ratio for recording and the compression ratio for sending are set different from each other, data to be recorded and data to be sent are created from the image data held on the temporary memory, and after recording these data in the mutually different recording regions, the image data held on the temporary memory are deleted.

The structure above makes it possible to create the data to be recorded and the data to be sent respectively at appropriate compression ratios. Hence, for example, it is possible to send low compression ratio data to a server after recording high compression ratio data, or record low compression ratio data on a recording medium which has a large capacity.

In this manner, the image data can be effectively utilized at various compression ratios.

Other aspect of the present invention provides a digital camera which comprises: a data compressor which compresses image data obtained through image capturing; a temporary memory which holds the image data as they are before compressed by the data compressor; recorder which is capable of recording the data compressed by the data compressor on a recording medium; sender which is capable of sending the data compressed by the data compressor; and a compression ratio controller which is capable of independently setting a compression ratio for the data recorded by the recorder and a compression ratio for the data sent by the sender.

The data compressor compresses the image data at the compression ratios which are set by the compression ratio controller. In the event that different compression ratios are set for recording and sending by the compression ratio controller, if the sender is in a state ready to send the data, the data compressor compresses the data which are to be sent by the sender, and the compressed data are recorded on the recording medium by the recorder and sent by the sender. After sending, the data recorded on the recording medium are deleted, and the data compressor compresses the data which are to be recorded by the recorder, and the compressed data are recorded on the recording medium by the recorder.

In the structure above, the image data obtained through image capturing, namely, pre-compressed image data are held on the temporary memory. It is therefore possible to independently set the compression ratio for recording the image data and the compression ratio for sending the image data.

In the structure above, when the compression ratio for recording and the compression ratio for sending are set different from each other, data to be recorded and data to be sent are created from the image data held on the temporary memory, and as sending becomes ready, the compressed data to be sent are deleted after sent, and the image data held on the temporary memory are deleted after recording of the compressed data to be recorded.

The structure above makes it possible to create the data to be recorded and the data to be sent respectively at appropriate compression ratios. In addition, since the data recorded on the recording medium may be simply sent after failing to send the data, it is possible to redo sending in short period of time. Further, even once a large volume of data to be sent are recorded on the recording medium, this data can be deleted after sent and only data to be recorded may be recorded, and hence, the capacity of the recording medium is saved.

In this manner, the image data can be effectively utilized at various compression ratios.

Still other aspect of the present invention provides a digital camera which comprises: a data compressor which compresses image data obtained through image capturing; a temporary memory which holds the image data as they are before compressed by the data compressor; recorder which is capable of recording the data compressed by the data compressor; sender which is capable of sending any one of the image data as they are before compressed and the data compressed by the data compressor; and a compression ratio controller which is capable of independently setting a compression ratio for the data recorded by the recorder and a compression ratio for the data sent by the sender.

The data compressor compresses the image data at the compression ratios which are set by the compression ratio controller. In the event that than the compression ratio for the data to be sent by the sender is lower the compression ratio for the data to be recorded by the recorder or that the sender is to send the image data, the sender sends the data compressed by the data compressor or the image data, and after completion of sending, the recorder records the data compressed by the data compressor and the image data held on the temporary memory are deleted after completion of recording.

In the structure above, the image data obtained through image capturing, namely, pre-compressed image data are held on the temporary memory. It is therefore possible to independently set the compression ratio for recording the image data and the compression ratio for sending the image data.

In the structure above, in the event that the compression ratio set for sending is lower than the compression ratio set for recording or that the image data are to be sent without compressed, making the camera into a state to ready to send data is given a priority, and after sending the data, the data to be recorded are recorded and the image data held on the temporary memory are then deleted.

The structure above makes it possible to create the data to be recorded and the data to be sent respectively at appropriate compression ratios. In addition, since sending of a large volume of data to be sent is given a priority, the capacity of the recording medium is saved.

In this manner, the image data can be effectively utilized at various compression ratios.

Yet another aspect of the present invention provides a digital camera which comprises: a data compressor which compresses image data obtained through image capturing; a temporary memory which holds the image data as they are before compressed by the data compressor; recorder which is capable of recording any one of the image data as they are before compressed and the data compressed by the data compressor; sender which is capable of sending any one of the image data as they are before compressed and the data compressed by the data compressor; and a compression ratio controller which is capable of independently setting a compression ratio for the data recorded by the recorder and a compression ratio for the data sent by the sender.

When one of the data to be recorded and the data to be sent are the image data as they are before compressed by the data compressor, and the other are the data compressed by the data compressor, only the image data as they are before compressed are recorded on the recording medium by the recorder.

The data compressor compresses the image data above at the compression ratio which is set by the compression ratio controller before sending, whereby the other data are created.

In the structure above, the image data obtained through image capturing, namely, pre-compressed image data are held on the temporary memory. It is therefore possible to independently set the compression ratio for recording the image data and the compression ratio for sending the image data.

In the structure above, in the event that the image data are to be recorded or sent without compressed, only the pre-compressed image data are recorded on the recording medium. Where the image data are to be recorded without compressed and compressed data are to be sent, the pre-compressed image data held on the temporary memory or the pre-compressed image data recorded on the recording medium are read, compressed and then sent. Even when the image data are to be sent without compressed and compressed data are to be recorded, the pre-compressed image data remain held on the recording medium until sending completes, the pre-compressed image data held on the temporary memory or the pre-compressed image data recorded on the recording medium are read for the purpose of sending and sent as they directly are without compressed, and the data are compressed at a predetermined compression ratio and recorded.

The structure above makes it possible to create the data to be recorded and the data to be sent respectively at appropriate compression ratios. In addition, when image data are to be recorded or sent without compressed, it is not necessary to record both data to be recorded and data to be sent, and hence, only small capacities of the temporary memory, the recorder and the recording medium are used.

In this manner, the image data can be effectively utilized at various compression ratios.

In the digital cameras having the structures described above, the temporary memory preferably keeps holding the image data at least until completion of recording by the recorder is confirmed and sending by the sender is confirmed.

In the structures above, when completion of sending or recording fails to be confirmed, pre-compressed image data are not deleted. Hence, even when there is a trouble in recording or sending, since the image data still remain on the temporary memory, it is possible to redo recording or sending.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 shows a preferred embodiment of the present invention and is an appearance view of a digital camera;

FIG. 2 is a block structure diagram of a control system of the digital camera of FIG. 1;

FIG. 3 shows an example of displays shown in an image display device of the digital camera of FIG. 1;

FIG. 4 is a flow chart of operations of the digital camera of FIG. 1;

FIG. 5 is a flow chart continuing from FIG. 4;

FIG. 6 is a flow chart continuing from FIG. 4;

FIG. 7 is a flow chart continuing from FIG. 4;

FIG. 8 is a flow chart continuing from FIG. 4;

FIG. 9 is a flow chart continuing from FIG. 4; and

FIG. 10 is a flow chart continuing from FIG. 4.

### DETAILED DESCRIPTION OF THE PREFERRED EMBODIMENTS

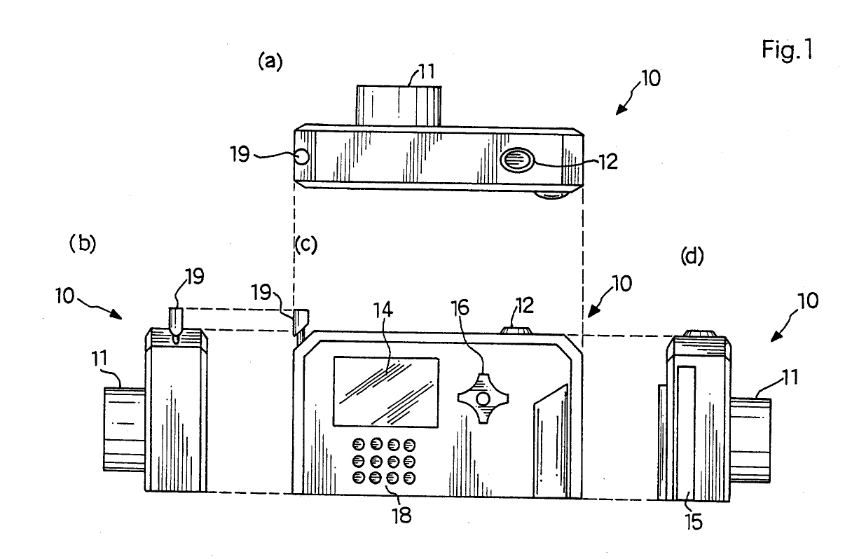

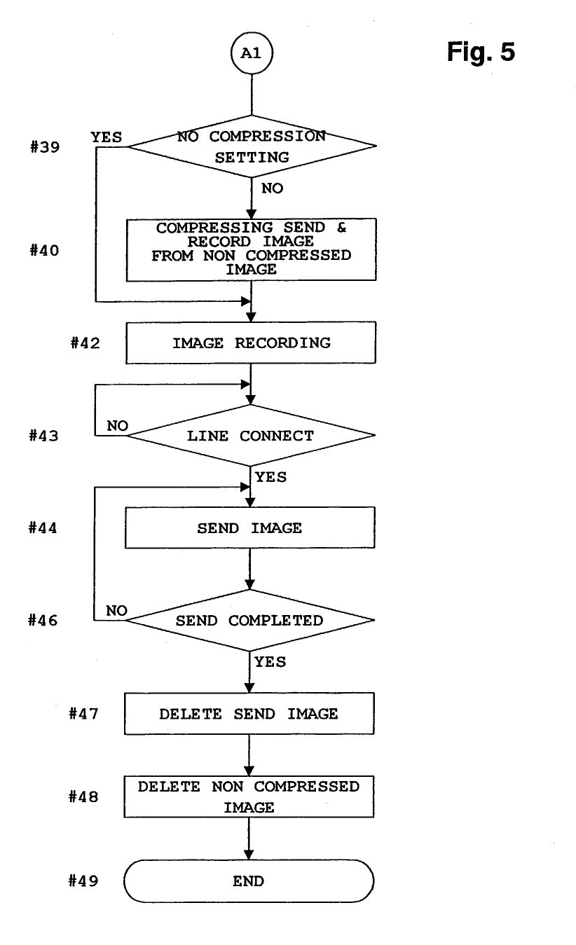

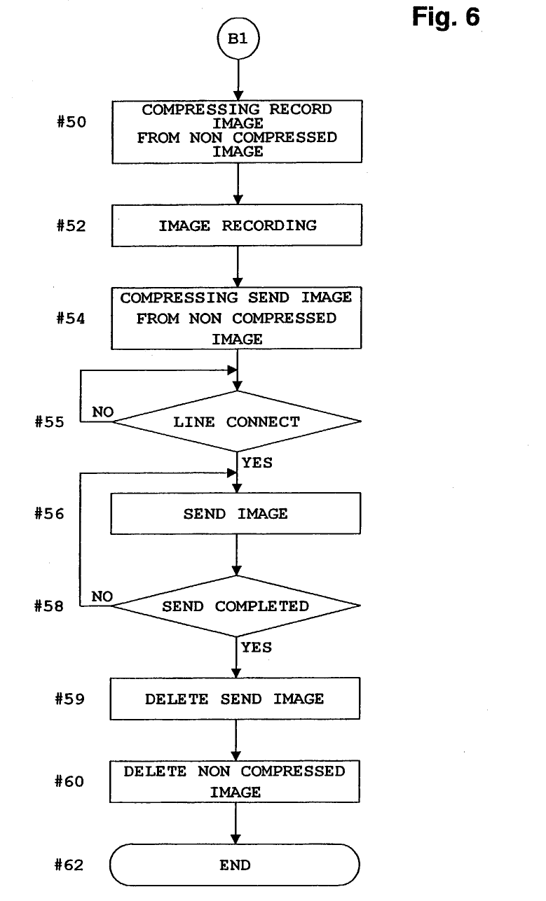

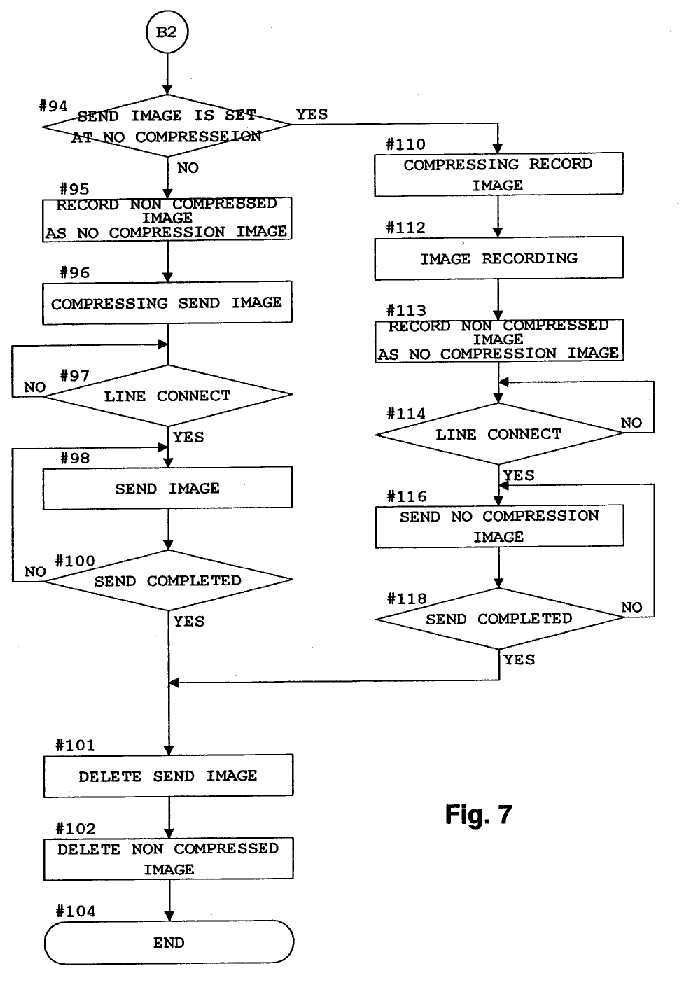

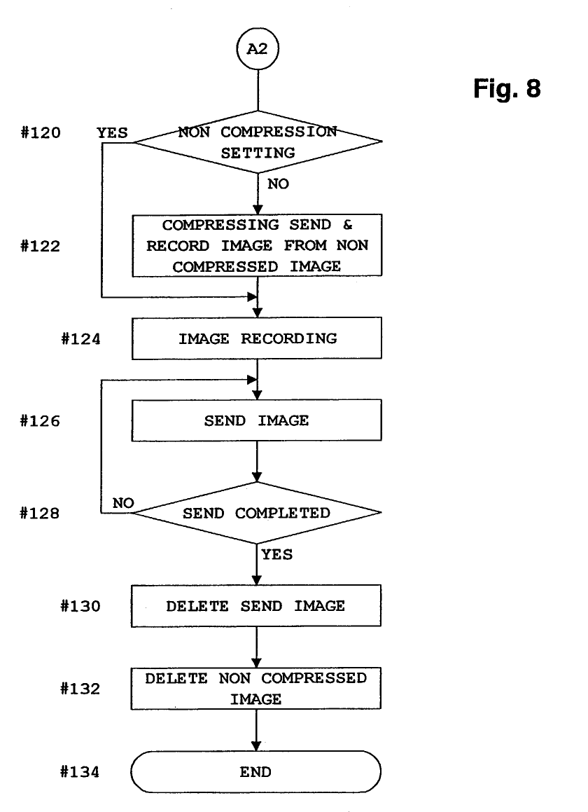

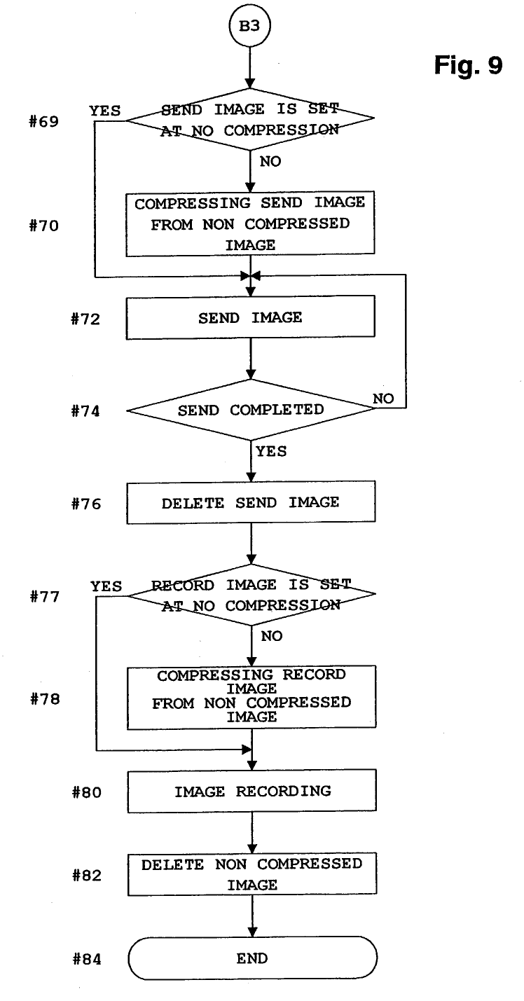

A preferred embodiment of the present invention will now be described with reference to FIGS. 1 through 10.

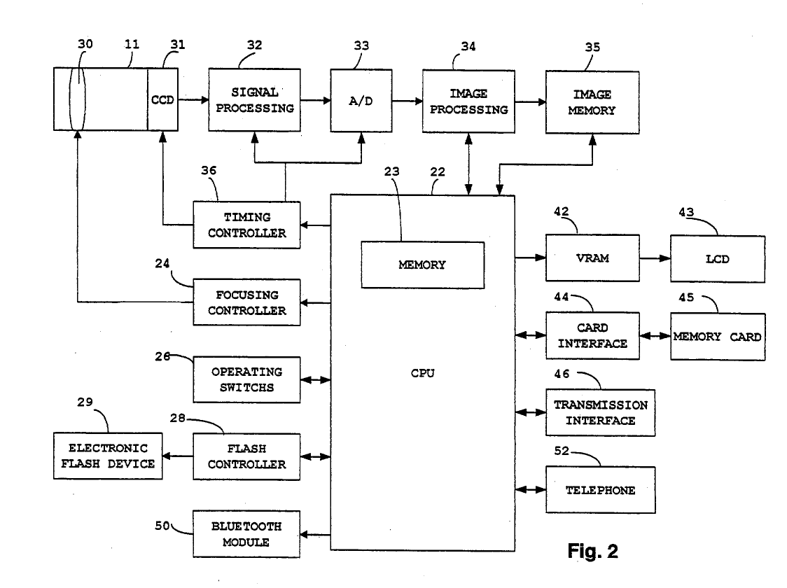

As shown in FIG. 1, a digital camera 10 comprises a lens 11, a shutter start button 12, an image display unit 14 which displays an image, a card slot 15 which receives a memory card 45 (See FIG. 2.), a cross button 16 which is used to make a selection or for other purposes, various types of operation buttons 18, an antenna 19, an electronic flash device not shown and the like, and is equipped with a portable telephone function.

In FIG. 2, a CPU 22 is connected to a ROM not shown in which a control program, tables, data and the like are stored, and governs overall control of the digital camera 10.

The CPU 22 is connected to a control circuit for focal point adjustment 24 which drives a focusing lens 30 which is inside the lens 11, a timing control unit 36, an image processing circuit 34, an image memory 35 which temporarily stores an output signal from the image processing circuit 34, an operation switch 26 which is activated by the cross button 16 and the operation buttons 18, a flash device control unit 28 which controls emission light from an electronic flash device 29, a VRAM 42 which is connected to a liquid crystal panel 43 of the image display unit 14, a card interface 44 which connects with the memory card 45 inserted in the card slot 15, a communications interface 46 for connection with a personal computer, a printer and the like, a Bluetooth™ transmission module 50 to communicate with other digital cameras, and a portable telephone function unit 52 which serves as a portable telephone and conducts transmission with a base station.

The timing control unit 36 controls a CCD 31 whose light receiving surface is located at an imaging position of the lens 11, a signal processing unit 32 which performs signal processing, such as noise removal, upon an output signal from the CCD 31, and an A/D conversion unit 33 which converts an analog signal from the signal processing unit 32 into a digital signal. The image processing circuit 34 receives a digital signal from the A/D conversion unit 33 (hereinafter referred to as “RAW data”), and after calculating R-color data, G-color data and B-color data by means of pixel interpolation, executes image processing such as black level correction, white balance adjustment and γ-characteristic correction of pixel data.

The CPU 22 comprises an internal memory 23, and temporarily records pre-compressed image data received from the image processing circuit 34. The CPU 22 also compresses image data which are recorded on the internal memory 23.

Separately from a first recording region for recording data which are intended to be recorded on the memory card 45, the memory card 45 comprises a second recording region for temporarily recording data which are intended to be sent by the Bluetooth™ transmission module 50 or the portable telephone function unit 52 before sending the data.

The Bluetooth™ transmission module 50 is for wireless communications with other equipment (such as other cameras and printers for instance), and sends and receives data by a wireless connection scheme (Bluetooth™) using the 2.45 GHz band. A transmission module which executes wireless communications by other scheme may be used instead of the Bluetooth™ transmission module 50.

The portable telephone function unit 52 sends data to a server or the like on a telephone line.

The portable telephone function may be omitted from the digital camera 10, in which case the antenna 19, the portable telephone function unit 52 and the like are not necessary.

Alternatively, the Bluetooth™ transmission module 50 may be omitted from the digital camera 10.

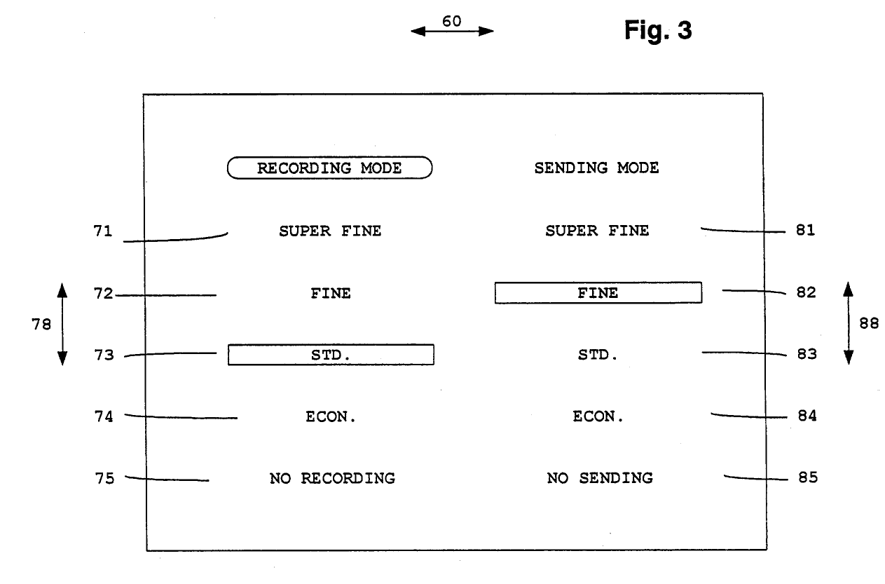

FIG. 3 shows an example of displays which the image display unit 14 shows for setting up the mode of the digital camera 10. In an upper section of the image display unit 14, there are a display 70 which reads “RECORD MODE” and a display 80 which reads “SEND MODE.” Located under the display 70 reading “RECORD MODE” are displays 71 through 75 which are options to be chosen under the record mode, and located under the display 80 reading “SEND MODE” are displays 81 through 85 which are options to be chosen under the send mode.

As one presses the right-hand side and the left-hand side projections of the cross button 16, a display 62 requesting mode selection moves to the right-hand side and the left-hand side as denoted at the arrow 60 so that one can select either the record mode or the send mode. As one presses the top and the bottom projections of the cross button 16 with “RECORD MODE” selected, a display 76 requesting for selection moves to above and below as denoted at the arrow 78 so that one can select an image data size (data capacity) for recording on the memory card 45. Alternatively, one can select not to record on the memory card 45. As one presses the top and the bottom projections of the cross button 16 with “SEND MODE” selected, a display 86 requesting for selection moves to above and below as denoted at the arrow 88 so that one can select an image data size (pixel number) for sending data to other camera by the Bluetooth™ transmission module 50 or for sending data to a server or the like on a telephone line by the portable telephone function unit 52. Alternatively, one can select not to send image data.

More specifically, as one selects the displays 71 and 81 reading “SUPER FINE,” image data, namely, data recorded on the internal memory 23 are recorded or sent as they remain in the TIFF format without getting compressed. When one selects the displays 72 and 82 reading “FINE,” the image data are compressed down to about ⅕ in the JPEG format and then recorded or sent. When one selects “STD.” denoted at the displays 73 and 83, the image data are compressed down to about 1/10 in the JPEG format and then recorded or sent. When one selects “ECON.” denoted at the displays 74 and 84, the image data are compressed down to about 1/25 in the JPEG format and then recorded or sent. As one selects the display 75 reading “NO RECORDING,” the image data do not get recorded. As one selects the display 85 reading “NO SENDING,” the image data do not get sent. The display 75 reading “NO RECORDING” and the display 85 reading “NO SENDING” can not be selected at the same time.

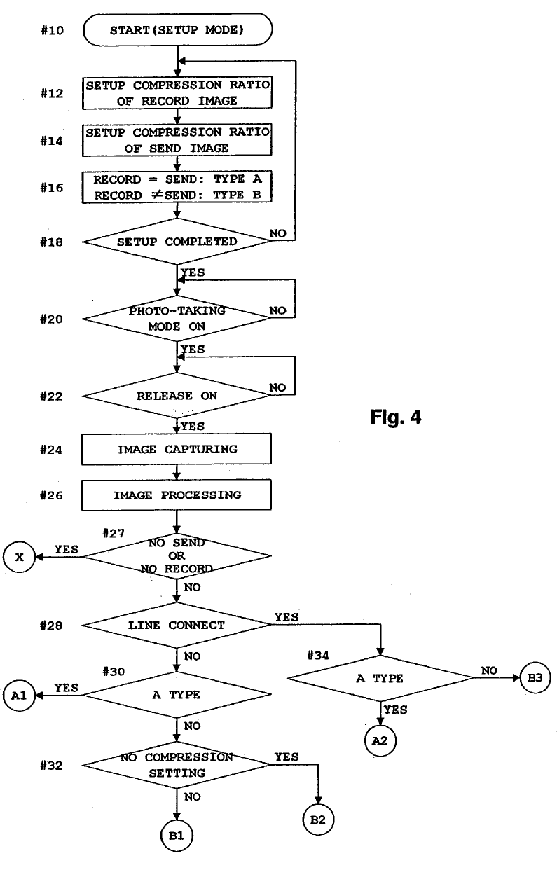

FIGS. 4 through 10 are flow charts of operations of the digital camera 10 in a case that data are sent to outside using the portable telephone function unit 52.

First, a setup mode is initiated (#10), and a condition regarding recording and sending is set up. That is, the options 71 through 75 for the record mode are displayed and a selection is accepted, so that a compression ratio for recording image data is set up (#12). At this stage, one can select “NO RECORDING.” Meanwhile, the options 81 through 85 for the record mode are displayed and a selection is accepted, so that a compression ratio for sending image data is set up (#14). At this stage, one can select “NO SENDING.” The compression ratio for images to be recorded set at the step #12 and the compression ratio for images to be sent set at the step #14 are compared with each other, and the situation is determined to be a type A when the two are the same whereas the situation is determined to be a type B when the two are different. The steps #12 through #16 are repeated until the end of the setup mode is confirmed (NO at #18).

Upon completion of the setup mode (YES at #18), the digital camera waits for a shooting mode (NO at #20).

Entering the shooting mode (YES at #20), the digital camera waits for the shutter start button 12 to be pressed (NO at #22). As the shutter start button 12 is pressed (YES at #22), the CCD 31 captures an image (#24), image processing is executed, and image data are stored as they are not compressed on the internal memory 23 of the CPU 22.

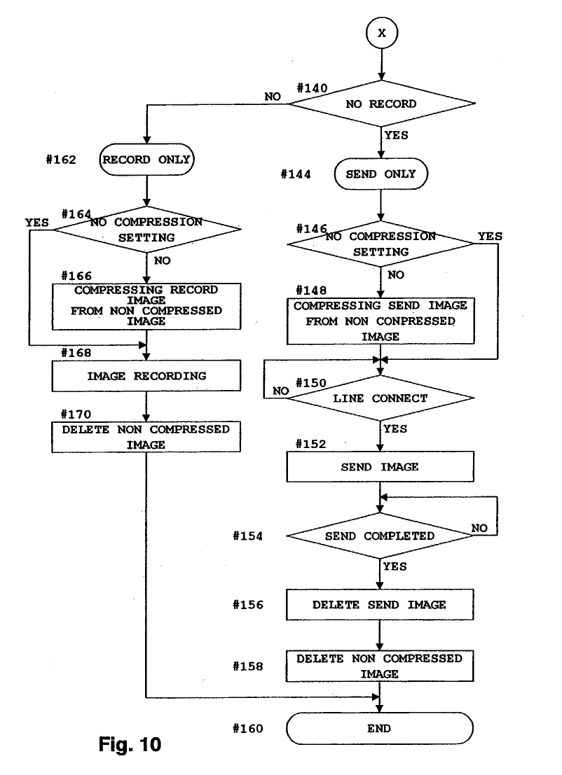

Next, in the setup mode, whether either “NO RECORDING” or “NO SENDING” has been chosen (#27) is determined. When either one has been chosen, the digital camera shifts to operations which are shown in FIG. 10 and will be described later. When non has been chosen, that is, when setup requires both recording and sending, whether the portable telephone function unit 52 is connected to a telephone line is determined (#28). This is to ensure that sending overrides when there is established connection during operations which will be described later.

When there is not established connection with a telephone line (NO at #28), whether the situation is the type A is determined (#30).

When it is the type A, that is, when the compression ratio for recording and that for sending are the same (YES at #30), whether an image to be recorded and an image to be sent are set to remain non-compressed (SUPER FINE) is determined (#39). The CPU 22 reads the image data from the internal memory 23, and when the images are not set to be non-compressed (NO at #39), the CPU 22 compresses the image data at the set compression ratio (#40). When the images are set to be non-compressed (YES at #39), the CPU 22 makes thus read image data recorded as they are in the first and the second recording regions of the memory card 45 as data of an image to be recorded (#42). Next, the digital camera waits until the portable telephone function unit 52 gets connected to a telephone line (#43). As connection with a telephone line is established, the portable telephone function unit 52 sends the data in the second recording region (#44). Upon completion of sending (YES at #46), the image to be send which are stored in the second recording region and the image data on the internal memory 23 are deleted (#47, #48), and the operation is terminated (#49).

Even when sending fails (NO at #46), since it is possible to read out the compressed data from the second recording region of the memory card 45, sending can be started over again in a shorter period of time than to read the data from the internal memory 23 and redo the compression.

When the situation is not the type A (NO at #30), whether an image to be recorded or an image to be sent is set to stay non-compressed (SUPER FINE) is determined (#32).

When neither is set to be non-compressed (NO at #32), the CPU 22 reads out the image data from the internal memory 23, compresses the data as an image to be recorded (#50), and records the compressed data in the first recording region of the memory card 45 as data of an image to be recorded (#52).

Next, the CPU 22 compresses the image data for an image to be sent, records the data in the second recording region of the memory card 45 (#54), and waits for the portable telephone function unit 52 to get connected to a telephone line (#55). As connection with a telephone line is established, the compressed data in the second recording region are sent (#56). Upon completion of sending, the image data are deleted from the second recording region and the internal memory 23 (#59, #60), and the operation is terminated (#62).

Even when sending fails (NO at #58), since it is possible to read out the compressed data from the second recording region of the memory card 45, sending can be started over again in a shorter period of time than to read the data from the internal memory 23 and redo the compression.

When non-compression has been set (YES at #32), whether an image to be sent is set to be non-compressed is determined (#94).

When an image to be sent is not set to be non-compressed, that is, when an image to be recorded is non-compressed (NO at #94), the image data read from the internal memory 23 are recorded as they are not compressed in the first recording region of the memory card 45 (#95). Following this, the image data thus read from the internal memory 23 are compressed to use as an image to be sent (#96), and the camera waits for the portable telephone function unit 52 to get connected to a telephone line (#97).

As connection with a telephone line is established (YES at #97), the compressed image data are sent (#98). Upon completion of sending (YES at #100), the image data in the second recording region and the non-compressed data in the internal memory 23 are deleted (#101, #102), and the operation is terminated (#104).

Even when sending fails (NO at #100), since it is possible to read out the compressed data from the second recording region of the memory card 45, sending can be started over again in a shorter period of time than to read the data from the internal memory 23 and redo the compression.

When an image to be sent is not set to be non-compressed (YES at #94), the image data thus read from the internal memory 23 are compressed to use as an image to be recorded (#110) and stored in the first recording region of the memory card 45 (#112), thus read image data are recorded in the second recording region as they directly are (#113), and the digital camera waits until the portable telephone function unit 52 gets connected to a telephone line (#114). As connection with a telephone line is established, the image data recorded in the second recording region are sent as data of an image to be sent (#116).

Upon failed sending (NO at #118), it is possible to read out the data from the second recording region of the memory card 45 and send the data once again.

Upon completion of sending (YES at #118), the image data to be sent in the second recording region and the non-compressed data in the internal memory 23 are deleted (#101, #102), and the operation is terminated (#104).

When connection with a telephone line is already established at the step #28 (NO at #28), whether the situation is the type A is determined (#34).

When it is the type A, that is, when the compression ratio for recording and that for sending are the same (YES at #34), whether an image to be recorded and an image to be sent are set to remain non-compressed (SUPER FINE) is determined (#120). The CPU 22 reads the image data from the internal memory 23. When an image to be recorded and an image to be sent are not set to be non-compressed (NO at #120), the CPU 22 compresses the image data at the set compression ratio (#122). When an image to be recorded and an image to be sent are set to be non-compressed (YES at #120), the CPU 22 records thus read image data in the first recording region and the second recording region of the memory card 45 as data of an image to be recorded (#124). In this case, since connection with a telephone line is already established, the portable telephone function unit 52 sends the data in the second recording region (#126). Upon completion of sending (YES at #128), the image data to be sent in the second recording region and the image data in the internal memory 23 are deleted (#130, #132), and the operation is terminated (#134).

Even when sending fails (NO at #128), since it is possible to read out the compressed data from the second recording region of the memory card 45, sending can be started over again in a shorter period of time than to read the data from the internal memory 23 and redo the compression.

When the situation is the type B, that is, when the compression ratio for recording and that for sending are different (NO at #34), whether an image to be sent is set to be non-compressed is determined (#69). When an image to be sent is not set to be non-compressed (NO at #69), the image data read from the internal memory 23 are compressed at the compression ratio which is set for sending (#70), and recorded in the second recording region of the memory card 45. When an image to be sent is set to be non-compressed (YES at #69), the image data read from the internal memory 23 are recorded in the second recording region as they directly are. The image data in the second recording region are then sent via the portable telephone function unit 52. Upon completion of sending (YES at #74), the image data to be sent which are in the second recording region of the memory card 45 are deleted (#76).

Even when sending fails (NO at #74), since it is possible to read out the compressed data from the second recording region of the memory card 45, sending can be started over again in a shorter period of time than to read the data from the internal memory 23 and redo the compression.

Following this, whether an image to be recorded is set to be non-compressed (#77) is determined. When an image to be recorded is not set to be non-compressed (NO at #77), the image data read from the internal memory 23 are compressed at the compression ratio which is set for recording (#78), and recorded in the first recording region of the memory card 45 (#80). When an image to be recorded is set to be non-compressed (YES at #77), the image data read from the internal memory 23 are recorded in the first recording region as they directly are.

The non-compressed data on the internal memory 23 are thereafter deleted (#82), and the operation is terminated (#84).

When any one of “NO RECORDING” and “NO SENDING” is chosen at the step #27 (YES at #27), which one between “NO RECORDING” and “NO SENDING” is chosen is determined (#140). As described earlier, since it is not possible to choose “NO RECORDING” and “NO SENDING” at the same time, only whether “NO RECORDING” is the selected one or “NO SENDING” is the selected one may be determined.

When “NO SENDING” is the selected one (YES at #140), recording alone is executed (#162). First, whether an image to be recorded is set to be non-compressed is determined (#164). When an image to be recorded is set to be non-compressed (YES at #164), the image data read from the internal memory 23 are recorded as they directly are in the first recording region of the memory card 45 (#168). When an image to be recorded is no set to be non-compressed (NO at #164), the image data read from the internal memory 23 are recorded in the first recording region (#168) after compressed at the set compression ratio (#166). The image data on the internal memory 23 are then deleted (#170), and the operation is terminated (#160).

When “NO RECORDING” is the selected one (NO at #140), sending alone is executed (#144). First, whether an image to be sent is set to be non-compressed is determined (#146). When an image to be sent is set to be non-compressed (YES at #146), the image data read from the internal memory 23 are recorded as they directly are in the second recording region of the memory card 45 as image data to be sent. When an image to be sent is set to be non-compressed (NO at #146), the image data read from the internal memory 23 are compressed at the set compression ratio and recorded in the second recording region of the memory card 45.

The digital camera now waits until the portable telephone function unit 52 gets connected to a telephone line (#150). As connection with a telephone line is established, the image data to be sent recorded in the second recording region are sent (#154). Upon completion of sending (YES at #154), the image data to be sent which are in the second recording region and the compressed image data on the internal memory 23 are deleted (#156, #158), and the operation is terminated (#160).

Operations remain similar for sending of data to external equipment using the communications interface 46, the Bluetooth™ transmission module 50 or the like.

As described above, the digital camera 10 can effectively utilize image data at various compression ratios.

That is, since it is possible to independently set a compression ratio for data to be recorded and that for data to be sent and it is possible to create a compression ratio for data to be recorded and that for data to be sent each from pre-compressed image data, an image quality does not deteriorate.

In addition, even as data to be sent are temporarily recorded on the memory card 45, since the data are deleted after sent and data to be recorded alone are accordingly recorded, the capacity in the memory card 45 is saved. For instance, in the event that an image compression ratio for data to be sent is low or data are to be sent without compressed, since sending of the data overrides and the data to be sent are deleted from the memory card 45 after completion of sending, the recording capacity is saved.

Further, where image data are to be recorded without compressed, recording alone is executed as an overriding job so that the data to be sent may be compressed and sent at a later time. This makes it possible to eliminate the necessity of recording the data to be sent at this later stage.

Moreover, since the internal memory 23 holds image data at least until recording of data and sending of data complete, it is possible to redo recording and sending.

The present invention is not limited to the preferred embodiment above but may be modified in a variety of manners.

For example, a recording region (e.g., RAM) may be disposed instead of the second recording region of the memory card 45, and data to be sent may be recorded in this recording region.

Although the foregoing has described that “image data as they are before compressed” are R-color data, G-color data and B-color data calculated through pixel interpolation based on RAW data in the preferred embodiment above, data recorded on the temporary memory may be RAW data, in which case as well the same effect is promised in the sense that deterioration of image is prevented.

Further, in the event that RAW data are added (not shown) to an image for which either the recording mode or the sending mode is selected in FIG. 3 so that any one between the RAW data and “SUPER FINE” (no compression) can be selected as pre-compressed image data, the RAW data may be recorded in the temporary memory as the RAW data are selected in any one of these modes but “SUPER FINE” may be otherwise recorded on a temporary memory.

The pre-compressed image data recorded on the temporary memory may be deleted immediately after sending, immediately after completion of recording on a recording medium or prior to the next round of shooting operations.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A camera which is capable of recording and sending image data, comprising:
a temporary memory which holds image data obtained through image capturing;
a data compressor which accepts setup regarding a compression ratio for sending and accepts setup regarding a compression ratio for recording, and accordingly compresses the image data recorded on the temporary memory at the respective compression ratios; and
a memory controller which ensures that the image data compressed at the compression ratio for sending and the image data compressed at the compression ratio for recording are recorded independently in different regions of a memory.

2. A digital camera comprising:
a data compressor which compresses image data obtained through image capturing;
a temporary memory which holds the image data as they are before compressed by the data compressor;
recorder which is capable of recording the data compressed by the data compressor on a recording medium;
sender which is capable of sending the data compressed by the data compressor; and
a compression ratio controller which is capable of independently setting a compression ratio for the data recorded by the recorder and a compression ratio for the data sent by the sender,
wherein the data compressor compresses the image data at the compression ratios which are set by the compression ratio controller.

3. A digital camera according to claim 2, wherein, in the event that different compression ratios are set for recording and sending by the compression ratio controller, when the sender is in a state ready to send the data, the data compressor compresses the data which are to be sent by the sender, and the compressed data are recorded on the recording medium by the recorder and sent by the sender.

4. A digital camera according to claim 3, wherein, after sending of the data, the data recorded on the recording medium are deleted, and the data compressor compresses the data which are to be recorded by the recorder, and the compressed data are recorded on the recording medium by the recorder.

5. A digital camera according to claim 2, wherein, in the event that when the compression ratio for the data to be sent by the sender is lower the compression ratio for the data to be recorded by the recorder or that the sender is to send the image data before compression, the sender sends the data compressed by the data compressor or the image data before compression, and
after completion of sending, the recorder records the data compressed by the data compressor.

6. A digital camera according to claim 5, wherein the image data held on the temporary memory are deleted after completion of recording.

7. A digital camera comprising:
a data compressor which compresses image data obtained through image capturing;
a temporary memory which holds the image data as they are before compressed by the data compressor;
recorder which is capable of recording any one of the image data as they are before compressed and the data compressed by the data compressor;
sender which is capable of sending any one of the image data as they are before compressed and the data compressed by the data compressor; and
a compression ratio controller which is capable of independently setting a compression ratio for the data recorded by the recorder and a compression ratio for the data sent by the sender.

8. A digital camera according to claim 7, wherein, when one of the data to be recorded and the data to be sent are the image data as they are before compressed by the data compressor, and the other are the data compressed by the data compressor, only the image data as they are before compressed are recorded on the recording medium by the recorder, and
wherein the data compressor compresses the image data above at the compression ratio which is set by the compression ratio controller before sending, whereby the other data are created.
